(19) United States
(12) Patent Application Publication
(10) Pub. No.: US 2011/0286789 A1
(43) Pub. Date: Nov. 24, 2011

(54) LATCHING SYSTEM FOR A BICYCLE

(76) Inventor: Antonius Gerardus Petrus Johannes Kooijmans, Eindhoven (NL)

(21) Appl. No.: 12/602,401

(22) PCT Filed: May 28, 2008
(86) PCT No.: PCT/NL08/50325

§ 371 Date: Aug. 2, 2011

(30) Foreign Application Priority Data
Jun. 1, 2007 (NL) 2000678

(51) Int. Cl. F16B 7/00

(52) U.S. Cl. 403/319

(57) ABSTRACT

A latching system has a frame having a U-shaped recess, and a latching element for closing the recess. The latching element is U-shaped in essence, one leg of which forming a latching pawl and the other leg forming a control pawl, and a connection member of which, pivotable around capstan, being connected to the frame. The latching element is pivotable between a release position, in which the latching pawl is situated outside the recess and the control pawl extends into the recess, and a latching position in which the latching pawl closes the recess in the frame and the control pawl is situated outside the recess. The latching system further includes a blocking mechanism which includes a movable blocking pin. The latching element is provided with notches with which in the latching position or release position respectively the blocking pin engages.

### FIELD OF THE INVENTION

The invention relates to a latching system for latching an object, more particularly a frame tube of a bicycle, which latching system comprises a frame provided with an essentially U-shaped recess, as well as a latching element for closing the recess.

### STATE OF THE ART

A latching system of this type is known from Dutch patent specification NL-A-1028581.

### SUMMARY OF THE INVENTION

It is an object of the invention to improve the known latching system. To this end the latching system according to the invention is characterized in that the latching element is U-shaped in essence, one leg of which forming a latching pawl and the other leg forming a control pawl and a connection member of which between the legs being pivotably connected to the frame, the latching element being pivotable between a release position, in which the latching pawl is situated outside the recess and the control pawl extends into the recess, and a latching position in which the latching pawl closes the recess in the frame and the control pawl is situated outside the recess.

An embodiment of the latching system according to the invention is characterized in that the latching system comprises a blocking mechanism provided with a movable blocking pin, and in that the latching element has recesses which in release position and latching position are available for the blocking pin, on actuation of the blocking mechanism the blocking pin being inserted into one of the recesses and blocking the latching element against turning.

The blocking mechanism preferably comprises a solenoid which is formed by a coil which includes a movable magnetic core which forms the blocking pin.

A further embodiment of the latching system according to the invention is characterized in that the latching system includes a spring which is connected to the frame with one end and is connected to the latching element with the other end, in such a way that the spring forces the latching element to adopt the release position or the latching position.

### BRIEF DESCRIPTION OF THE DRAWINGS

The invention will be described below in more detail based on an example of embodiment of the latching system according to the invention represented in the drawing figures, in which:

FIG. 1 shows an embodiment of the latching system according to the invention taken apart in components;

FIG. 2 shows a perspective view of the latching system in assembled state;

FIG. 3 shows a plan view of the latching system with the latching element in release position; and

FIG. 4 shows a plan view of the latching system with the latching element in latching position.

### DETAILED DESCRIPTION OF THE DRAWINGS

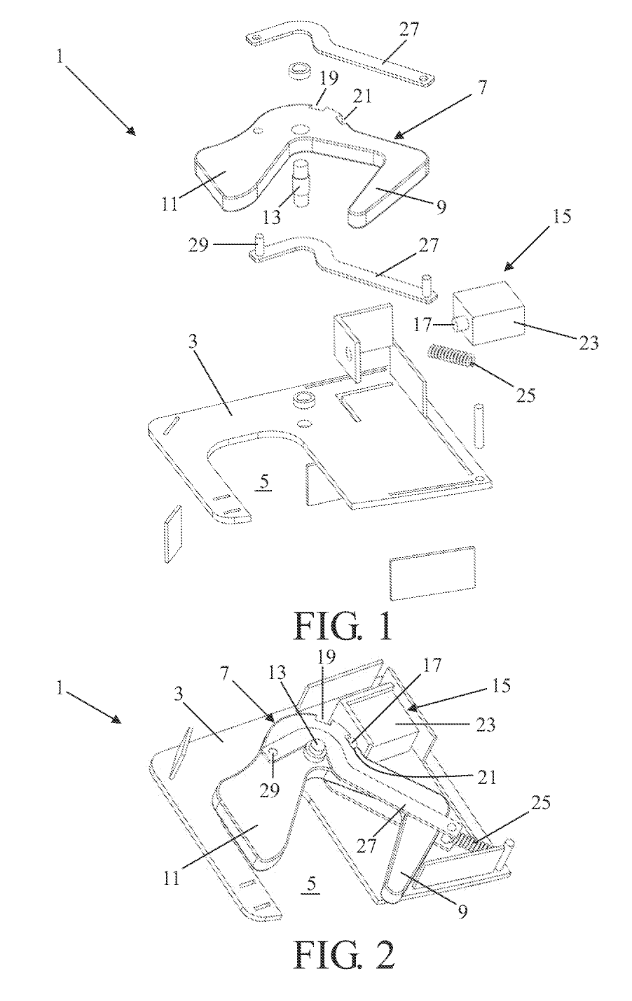

An embodiment of the latching system according to the invention is shown in drawing FIGS. 1-4. The latching system 1 has a frame 3 provided with a recess 5 which is U-shaped in essence, and a latching element 7 for closing the recess. The latching element 7 is U-shaped in essence, one leg of which forming a latching pawl 9 and the other leg forming a control pawl 11, and of which a connection member between the legs is connected to the frame 3 pivotably around capstan 13.

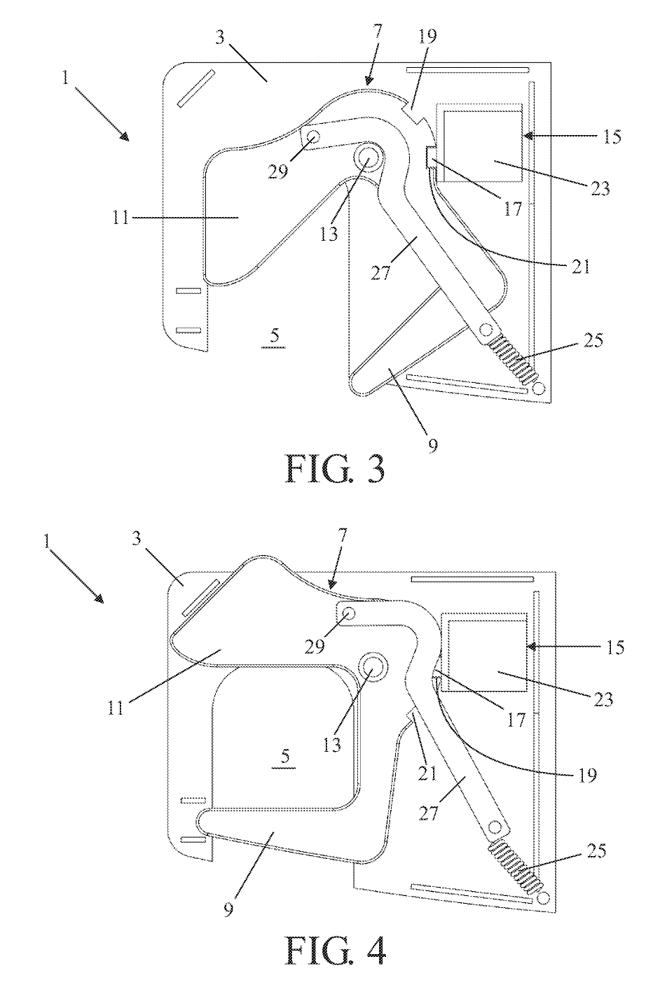

The latching element 7 is pivotable between a release position, see FIG. 3, in which the latching pawl 9 is situated outside the recess 5 and the control pawl 11 extends into the recess 5, and a latching position, see FIG. 4, in which the latching pawl 9 closes the recess 5 in the frame and the control pawl 11 is situated outside the recess 5.

The latching system 1 further has a blocking mechanism 15 which is provided with a movable blocking pin 17. The latching element 7 is provided with notches 19 and 21 with which in latching position (FIG. 4) or release position (FIG. 3) respectively, the blocking pin 17 engages. When the blocking mechanism 15 is actuated, the blocking pin 17 is extended into one of the notches 19, 21 and the latching element 7 is blocked against pivoting around capstan 13. The blocking mechanism 15 has a solenoid which is formed by a coil 23 which accommodates a movable magnetic core which forms the blocking pin 17.

The latching system 1 further includes a spring 25 which is connected with one end to the frame 3 and with the other end to an arm 27 which, pivotably around capstan 29, is connected to the latching element 7. The positions of the capstan 29, the arm 27 and the spring 25 are such that the spring always forces the latching element 7 to adopt one of the extreme positions (release position of FIG. 3 or latching position of FIG. 4).

Albeit the invention has been described in the foregoing based on the drawing figures, it should be observed that the invention is not by any manner or means restricted to the embodiment shown in the drawing figures. The invention also extends to all embodiments deviating from the embodiment shown in the drawing figures within the spirit and scope defined by the claims.

1. A latching system for latching an object, more particularly a frame tube of a bicycle, which latching system comprises a frame provided with an essentially U-shaped recess, as well as a latching element for closing the recess, characterized in that the latching element is U-shaped in essence, one leg of which forming a latching pawl and the other leg forming a control pawl and a connection member of which between the legs being pivotably connected to the frame, the latching element being pivotable between a release position in which the latching pawl is situated outside the recess and the control pawl extends into the recess, and a latching position in which the latching pawl closes the recess in the frame and the control pawl is situated outside the recess.

2. A latching system as claimed in claim 1, characterized in that the latching system comprises a blocking mechanism provided with a movable blocking pin, and in that the latching element is provided with notches which in release position and latching position are provided for the blocking pin, on actuation of the blocking mechanism the blocking pin being inserted into one of the recesses and blocking the locking element against turning.

3. A latching system as claimed in claim 2, characterized in that the blocking mechanism comprises a solenoid which is formed by a coil with a movable magnetic core inside it, which forms the blocking pin.

4. A latching system as claimed in claim 1, characterized in that the latching system includes a spring which is connected with one end to the frame and with the other end to the latching element in such a way that the spring forces the latching element to adopt the release position or to adopt the latching position.

5. A latching system for latching a frame tube of a bicycle, the latching system comprising:
a frame having an essentially U-shaped recess;
a latching element for closing the recess, the latching element being essentially U-shaped, one leg of which forms a latching pawl and the other leg forming a control pawl and a connection member of which between the legs being pivotably connected to the frame,
the latching element being pivotable between a release position in which the latching pawl is situated outside the recess and the control pawl extends into the recess, and a latching position in which the latching pawl closes the recess in the frame and the control pawl is situated outside the recess; and
a blocking mechanism provided with a movable blocking pin, and in that the latching element is provided with notches which in release position and latching position are provided for the blocking pin, on actuation of the blocking mechanism the blocking pin being inserted into one of the recesses and blocking the locking element against turning.
